(19) United States
(12) Patent Application Publication
(10) Pub. No.: US 2009/0165802 A1
(43) Pub. Date: Jul. 2, 2009

(54) SUPPLEMENTAL OXYGEN SYSTEM FOR AIRCRAFT AND METHOD THEREFOR

(76) Inventor: Hisham Farajallah, Seattle, WA (US)

Correspondence Address: THE BOEING COMPANY;c/o WEISS & MOY, P.C., 4204 N. BROWN AVE., SCOTTSDALE, AZ, 85251, US

(21) Appl. No.: 11/968,289

(22) Filed: Jan. 2, 2008

(51) Int. Cl. A62B 7/14; A62B 7/00; A62B 18/10

(52) U.S. Cl. 128/205.24; 128/205.25

(57) ABSTRACT

A system for supplying oxygen to a flight deck and cabin area of an aircraft has an oxygen supply. A T-fitting is coupled to the oxygen supply. A first regulator is coupled to a first outlet of the T-fitting to control a flow of oxygen out of the first outlet. A second regulator is coupled to a second outlet of the T-fitting to control a flow of oxygen out of the second outlet. At least one flight crew breathing mask is coupled to the first regulator. At least one cabin area breathing mask is coupled to the second regulator.

### BACKGROUND

Embodiments of this disclosure relate generally to an oxygen system for an aircraft, and more particularly, to a supplemental oxygen system for an aircraft which allows for different types of masks to be installed on a single system.

The Federal Aviation Administration (FAA) has different requirements for the flight crew and the passengers. The FAA requires that all pilots flying their aircraft above 12,500 feet for 30 minutes or longer or at 14,000 feet or above during the entire flight must use supplemental oxygen. The FAA also regulates that passengers must have supplemental oxygen available over 15,000 feet and that it is recommended that supplemental oxygen be used at night at altitudes over 5,000 feet.

Presently, aircraft have two separate supplemental oxygen systems. One system is designed for individuals in the passenger cabin of a passenger aircraft or the cargo area of a freight aircraft. A second system is designed for the flight crew on the flight deck of the aircraft (i.e., both the passenger and freight aircraft). In a passenger aircraft, a passenger oxygen system (hereinafter passenger system) is a continuous flow system. The passenger cabin system will have an oxygen mask comprised of a yellow facial cup with elastic bands for securing the mask to the face of an individual in the passenger cabin. The facial cup does not form an air tight seal around the face of the user. Thus, the facial cup does not provide protection from smoke.

In a freight aircraft, a supernumerary supplemental oxygen system (herein supernumerary system) provides supplemental oxygen to any individuals that may be seated in an area other than the flight deck of the freight aircraft. The supernumerary system is similar to the passenger system. The supernumerary system is a continuous flow system. The supernumerary system will have an oxygen mask comprised of a facial cup with elastic bands for securing the mask to the face of an individual in the cargo area. The facial cup does not form an air tight seal around the face of the user and does not provide protection from smoke. The main difference between the passenger system and the supernumerary system is that there are fewer oxygen masks in the supernumerary system. Since the passenger system and the supernumerary system are similar in nature, the discussion below will use the term passenger system to mean both the passenger system and the supernumerary system.

In the passenger system, the passenger oxygen masks cannot deliver enough oxygen for sustained periods at high altitudes. This is why the flight crew needs to place the aircraft in a controlled emergency dive to a lower altitude where it is possible to breathe without emergency oxygen. If there is a fire on board the aircraft, masks are not deployed, as the production of oxygen may further fuel the fire.

The passenger system may be one of two types. The first system is a gaseous manifold system which connects all oxygen masks to a central oxygen supply. The central oxygen supply is usually stored in the cargo hold area of the aircraft. When a user pulls down on the oxygen mask, a continuous flow of oxygen will start to flow to that specific mask only. This type of system can usually be reset in the flight deck or in some other location in the aircraft

The second system is a chemical oxygen generator. In this system, pulling down on one oxygen mask removes the firing pin of the generator igniting a mixture of sodium chlorate and iron powder that supplies a continuous flow of oxygen which is sent to all the masks in the compartment. Oxygen production cannot be shut off once a mask is pulled, and oxygen production typically lasts for 12-22 minutes.

The flight crew oxygen system (hereinafter flight crew system) is a continuously pressurized system. The flight crew system generally have oxygen masks that are designed to provide a tight fit without leakage for long duration oxygen breathing by the flight crew. The oxygen mask are placed in front or to the side of the flight crew member unlike the passenger cabin system wherein the mask will fall from a housing mounted in the ceiling structure of the passenger cabin. The flight crew system further allows for controlling the content and flow to the mask. Unlike the passenger cabin system which only allows for a continuous flow of oxygen at a predefined pressure, the flight crew system has multiple options. The flight crew system allows for a mixture of air and oxygen, one hundred percent oxygen, and a slightly positive pressure oxygen, wherein the pressure is slightly higher then atmospheric which prevents any smoke from getting in to the mask and thus the eyes, nose, throat, etc. of the flight crew member.

Both the passenger system and the flight crew system have different types of oxygen mask and different system requirements. Presently there is not a single system which can provide for the requirements of both the flight crew system and the passenger system. Because of this, current aircraft have two separate supplemental oxygen systems housed in the aircraft. The use of two separate oxygen systems increases the cost in terms of installation and maintenance of the multiple systems. Furthermore, multiple oxygen systems increase the weight and take up valuable space in the aircraft which could be used for other purposes.

Therefore, it would be desirable to provide an apparatus and method that overcomes the above problems. The apparatus and method would provide for a single supplemental oxygen system which could accommodate multiple types of masks and the different requirements of the flight deck and the passenger cabin of the aircraft.

### SUMMARY

A system for supplying oxygen to a flight deck and cabin area of an aircraft has an oxygen supply. A T-fitting is coupled to the oxygen supply. A first regulator is coupled to a first outlet of the T-fitting to control a flow of oxygen out of the first outlet. A second regulator is coupled to a second outlet of the T-fitting to control a flow of oxygen out of the second outlet. At least one flight crew breathing mask is coupled to the first regulator. At least one cabin area breathing mask is coupled to the second regulator.

A system for supplying oxygen to a flight deck and cabin area of an aircraft has a T-fitting coupled to the oxygen supply of a flight deck breathing system of the aircraft. A first regulator is coupled to a first outlet of the T-fitting to provide a continuous flow of oxygen at a predefined pressure out of the first outlet. A flow control unit is coupled to a second outlet of the T-fitting to control a flow of oxygen out of the second outlet. The flow control unit allows oxygen to flow upon decompression of the aircraft. At least one flight crew breathing mask is coupled to the first regulator. At least one cabin area breathing mask coupled to the flow control unit.

A system for supplying oxygen to a flight deck and cabin area of an aircraft has a flight deck breathing system for supplying one of ambient air, oxygen, or a mixture of air and oxygen to the flight deck. A T-fitting is coupled to the flight deck breathing system. A first regulator is coupled to a first outlet of the T-fitting to provide a continuous flow of oxygen at a predefined pressure out of the first outlet. A second regulator is coupled to a second outlet of the T-fitting to control a flow of oxygen out of the second outlet. At least one flight crew breathing mask is coupled to the first regulator. At least one cabin area breathing mask is coupled to the second regulator.

The features, functions, and advantages can be achieved independently in various embodiments of the disclosure or may be combined in yet other embodiments.

### BRIEF DESCRIPTION OF THE DRAWINGS

Embodiments of the disclosure will become more fully understood from the detailed description and the accompanying drawings, wherein:

FIG. 1 is a simplified block diagram of a supplemental oxygen system for an aircraft;

FIG. 2 is simplified block diagram of the supplemental oxygen system installed in an existing flight deck breathing system; and

FIG. 3 is a block diagram showing the supplemental oxygen system installed in an existing flight deck breathing system.

### DETAILED DESCRIPTION

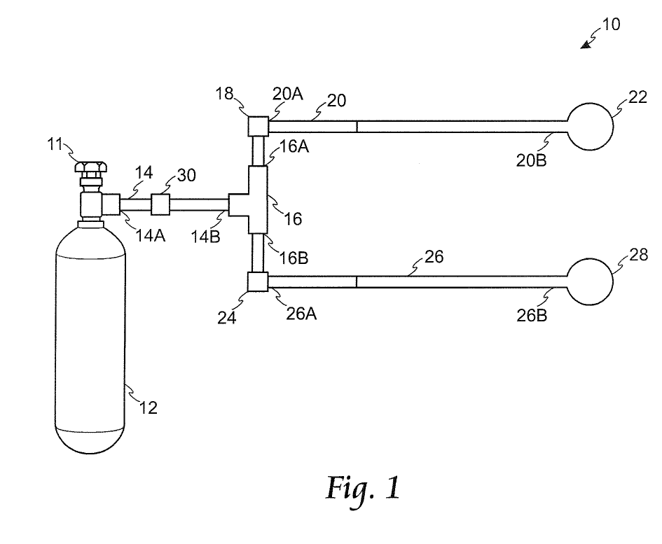

With reference now to the FIGS. 1, a simplified block diagram of a supplemental oxygen system 10 (hereinafter system 10) is shown. The system 10 provides a single system which could accommodate multiple types of oxygen masks and the different Federal Aviation Administration (FAA) requirements for supplemental oxygen for both passenger and freight aircraft. The discussion below is in regards to a passenger aircraft but is also application to freight aircraft.

The system 10 has an oxygen source 12. The oxygen source 12 will provide supplemental oxygen to the flight deck crew and to individuals in the cabin area of the aircraft. The oxygen source 12 is generally one or more high pressure oxygen cylinders stored in the cargo area of the aircraft. A control device 11 is generally coupled to the oxygen source 12. The control device 11 is used to release and stop the flow of oxygen from the oxygen source 12.

A first piece of tubing 14 has a first end 14A coupled to the oxygen supply 12. The tubing 14 is used to deliver the oxygen from the oxygen supply 12 to the flight deck crew and to individuals in the cabin area of the aircraft. A T-fitting 16 is coupled to a second end 14B of the tubing 14. An input to the T-fitting 16 is coupled to the second end of the tubing 14. The T-fitting 16 has a pair of outputs 16A and 16B. The outputs 16A and 16B are used to create two separate oxygen supply pathways, one pathway to the flight deck and a second pathway to the passenger cabin of the aircraft.

A regulator 18 is coupled to the output 16A of the T-fitting 16. The regulator 18 is used to control the flow of oxygen out of the output 16A in order to maintain a desired pressure. To conform to FAA requirements, the regulator 18 will provide a continuous flow of oxygen at a predefined range. A second piece of tubing 20 is used to convey the pressurized oxygen from the regulator 18 to the flight deck. A first end 20A of the tubing 20 is coupled to an output of the regulator 18. A second end 20B of the tubing 20 is generally coupled to a flight deck oxygen mask 22. The oxygen mask 22 is of the type that provides a tight fit without leakage for long duration oxygen breathing by the flight crew.

A regulator 24 is coupled to the output 16B of the T-fitting 16. In general, the regulator 24 is not active and does not convey any pressurized oxygen until activated. A third piece of tubing 26 is used to convey pressurized oxygen from the regulator 24 to the passenger cabin of the aircraft when the regulator 24 is activated. A first end 26A of the tubing 26 is coupled to an output of the regulator 24. A second end 26B of the tubing 26 is generally coupled to one or more passenger cabin oxygen mask 28. In accordance with one embodiment, the passenger cabin oxygen mask 28 is comprised of a yellow facial cup with elastic bands for securing the mask to the face of an individual in the passenger cabin. However, the passenger cabin oxygen mask 28 may be similar to the flight deck oxygen mask 22 and provide a tight fit without leakage.

As stated above, in general, there is no flow of pressurized oxygen through the tubing 26. In accordance with one embodiment, the regulator 24 is a flow control unit 24. The flow control unit 24 is an altitude sensing high flow pressure regulator that provides precise oxygen flow to all passenger cabin oxygen masks 28 in the event of decompression. When the flow control unit 24 senses decompression of the aircraft, the flow control unit 24 is activated. Oxygen will flow to all passenger cabin oxygen masks 28 via the tubing 26. An additional regulator 30 may be positioned between the oxygen source 12 and the T-fitting 16. The regulator 30 is placed in the tubing 14 between the oxygen source 12 and the T-fitting 16. The regulator 30 is used to control the flow of oxygen out of the oxygen source 12 in order to maintain a desired pressure.

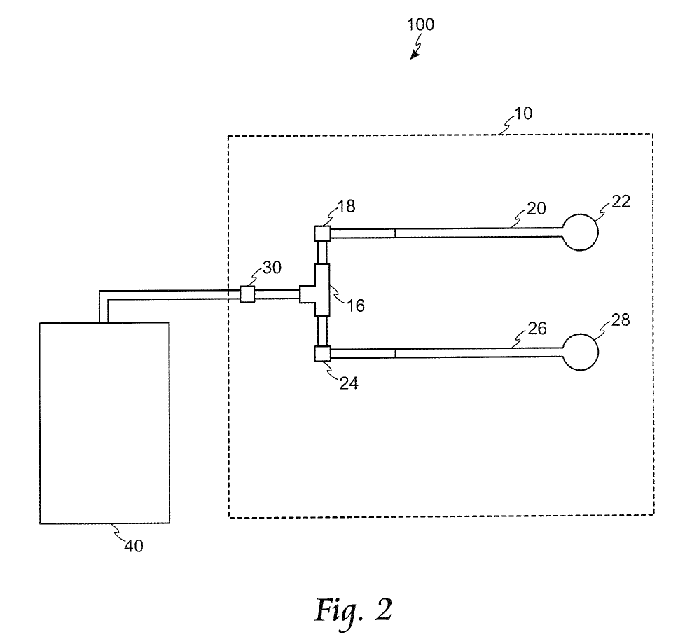

Referring to FIG. 2, the system 10 may be used with an existing flight crew oxygen system 40 to provide a single supplemental oxygen system 100 for an aircraft. The system 10 allows one to remove the existing passenger oxygen system since the system 10 provides emergency oxygen to both the flight deck and the passenger cabin. The oxygen supply of the flight crew oxygen system 40 may be used as the oxygen source 12 of the system 10.

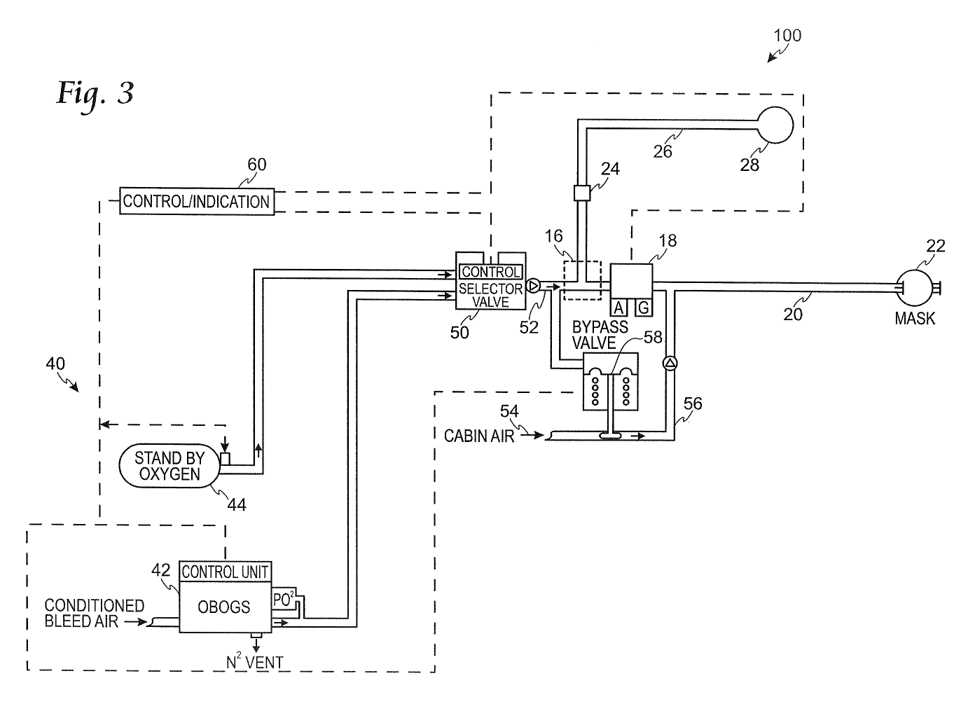

Referring to FIG. 3, the single supplemental oxygen system 100 for an aircraft is shown which includes the system 10. In the embodiment depicted in FIG. 3, the system 10 uses the oxygen supply of the flight crew oxygen system 40. The T-fitting 16 is positioned at the output of a selector valve 50. The selector valve 50 is used to select between different oxygen supplies of the flight deck breathing system 40. The regulator 18 is coupled to the output 16A of the T-fitting 16. The regulator 18 is used to control the flow of oxygen out of the output 16A in order to maintain a desired pressure. The first end 20A of the tubing 20 is coupled to the output of the regulator 18. The second end 20B of the tubing 20 is generally coupled to a flight deck oxygen mask 22. The oxygen mask 22 is of the type that provides a tight fit without leakage for long duration oxygen breathing by the flight crew.

The regulator 24 is coupled to the output 16B of the T-fitting 16. The first end 26A of the tubing 26 is coupled to an output of the regulator 24. The second end 26B of the tubing 26 is generally coupled to one or more passenger cabin oxygen mask 28. In accordance with one embodiment, the passenger cabin oxygen mask 28 is comprised of a yellow facial cup with elastic bands for securing the mask to the face of an individual in the passenger cabin.

Oxygen is supplied in the flight crew oxygen system 40 from either an onboard oxygen generating system (OBOGS) 42 or a stand-by oxygen supply 44. First and second airflow ducts 46 and 48 are used to deliver the oxygen from the OBOGS 42 and stand-by oxygen supply 44 respectively to a selector valve 50. The selector valve 50 is used to select breathing gas from only one of the two supplies, either the OBOGS 42 or the stand-by oxygen supply 44. After such selection is made, the selector valve 50 communicates breathing gas from the selected source into a third airflow duct 52. The third airflow duct 52 connects the selector valve to the T-fitting 16.

The flight crew oxygen system 40 may also supply ambient air 54 through a fourth airflow duct 56 in response to breathing gas feed pressure in the third airflow duct 52. A bypass valve 58 is positioned in the fourth airflow duct 54 for the purpose of permitting or blocking airflow therein depending on the feed pressure in the third airflow duct 52.

The flight crew oxygen system 40 will generally have a control unit 60. The control unit 60 may be a microprocessor, control circuit, or the like. The control unit 60 is used to control operation of the flight crew oxygen system 40. The control unit 60 sends signals to the selector valve 50, the regulator 18, and the bypass valve 58 in order to control the content and flow of gases to the flight deck oxygen mask 22. The control unit 60 may further be coupled to the OBOGS 42 and the stand-by oxygen supply 44 to activate and deactivate the flow of oxygen from the OBOGS 42 and the stand-by oxygen supply 44. The controller 60 also provides signals to the indication panel 62 indicating which of the breathing gas sources is in use.

In operation, a flight deck crew member uses the control unit 60 to select one of: ambient air, a mixture of ambient air and oxygen, one hundred percent oxygen, and high pressure oxygen to be sent to the mask 22. The control unit 60 sends signals to one or more of the selector valve 50, bypass valve 58, and the regulator 18 in order to provide the selected mixture of gases to the flight deck oxygen mask 22. Under normal conditions, there is no flow of pressurized oxygen through the tubing 26. When the flow control unit 24 senses decompression of the aircraft, the flow control unit 24 is activated. Oxygen will flow to all passenger cabin oxygen masks 28 via the tubing 26. The oxygen will be provided from either an onboard oxygen generating system (OBOGS) 42 or a stand-by oxygen supply 44 depending on the position of the selector valve 50.

The system 10 provides a single supplemental oxygen system for an aircraft. The system 10 allows one to remove the existing passenger oxygen system since the system 10 provides emergency oxygen to both the flight deck and the passenger cabin. The system 10 uses two different types of regulators. One regulator provides a continuous supply of oxygen at a predetermined range while the system downstream of the second regulator is not pressurized unless the second regulator is activated.

While embodiments of the disclosure have been described in terms of various specific embodiments, those skilled in the art will recognize that the embodiments of the disclosure can be practiced with modifications within the spirit and scope of the claims.

What is claimed is:

1. A system for supplying oxygen to a flight deck and cabin area of an aircraft comprising:
an oxygen supply;
a T-fitting coupled to the oxygen supply;
a first regulator coupled to a first outlet of the T-fitting to control a flow of oxygen out of the first outlet;
a second regulator coupled to a second outlet of the T-fitting to control a flow of oxygen out of the second outlet;
at least one flight crew breathing mask coupled to the first regulator; and
at least one cabin area breathing mask coupled to the second regulator.

2. A system for supplying oxygen to a flight deck and cabin area of an aircraft in accordance with claim 1 wherein the cabin area breathing mask is unpressurized until the second regulator is activated.

3. A system for supplying oxygen to a flight deck and cabin area of an aircraft in accordance with claim 1 wherein the second regulator is a flow control unit which provides oxygen flow to the cabin area breathing mask upon decompression of the aircraft.

4. A system for supplying oxygen to a flight deck and cabin area of an aircraft in accordance with claim 1 further comprising a third regulator coupled to the oxygen supply and the T-fitting to control the flow of oxygen out of the oxygen supply.

5. A system for supplying oxygen to a flight deck and cabin area of an aircraft in accordance with claim 1 wherein the oxygen supply is a high pressure oxygen container.

6. A system for supplying oxygen to a flight deck and cabin area of an aircraft in accordance with claim 5 further comprising a control device coupled to the high pressure oxygen container to release and stop the flow of oxygen from the high pressure oxygen container.

7. A system for supplying oxygen to a flight deck and cabin area of an aircraft in accordance with claim 1 wherein the oxygen supply is an oxygen supply of a flight deck breathing system in the aircraft.

8. A system for supplying oxygen to a flight deck and cabin area of an aircraft in accordance with claim 1 wherein the oxygen supply is one of an oxygen tank or an onboard oxygen generating system (OBOGS) of a flight deck breathing system installed in the aircraft.

9. A system for supplying oxygen to a flight deck and cabin area of an aircraft comprising:
a T-fitting coupled to the oxygen supply of a flight deck breathing system of the aircraft;
a first regulator coupled to a first outlet of the T-fitting to provide a continuous flow of oxygen at a predefined pressure out of the first outlet;
a flow control unit coupled to a second outlet of the T-fitting to control a flow of oxygen out of the second outlet, the flow control unit allowing oxygen flow upon decompression of the aircraft;
at least one flight crew breathing mask coupled to the first regulator; and
at least one cabin area breathing mask coupled to the flow control unit.

10. A system for supplying oxygen to a flight deck and cabin area of an aircraft in accordance with claim 9 wherein the cabin area breathing mask is unpressurized until the flow control unit is activated.

11. A system for supplying oxygen to a flight deck and cabin area of an aircraft in accordance with claim 9 further comprising a second regulator coupled to the oxygen supply and the T-fitting to control the flow of oxygen out of the oxygen supply.

12. A system for supplying oxygen to a flight deck and cabin area of an aircraft in accordance with claim 9 wherein the oxygen supply is one of an oxygen tank or an onboard oxygen generating system (OBOGS) of a flight deck breathing system installed in the aircraft.

13. A system for supplying oxygen to a flight deck and cabin area of an aircraft comprising:
a flight deck breathing system for supplying one of ambient air, oxygen, or a mixture of air and oxygen to the flight deck;
a T-fitting coupled to the flight deck breathing system;
a first regulator coupled to a first outlet of the T-fitting to provide a continuous flow of oxygen at a predefined pressure out of the first outlet;
a second regulator coupled to a second outlet of the T-fitting to control a flow of oxygen out of the second outlet;
at least one flight crew breathing mask coupled to the first regulator; and
at least one cabin area breathing mask coupled to the second regulator.

14. A system for supplying oxygen to a flight deck and cabin area of an aircraft in accordance with claim 13 wherein the cabin area breathing mask is unpressurized until the second regulator is activated.

15. A system for supplying oxygen to a flight deck and cabin area of an aircraft in accordance with claim 13 wherein the second regulator is a flow control unit.

16. A system for supplying oxygen to a flight deck and cabin area of an aircraft in accordance with claim 13 wherein the second regulator is a flow control unit which provides oxygen flow to the cabin area breathing mask upon decompression of the aircraft.

17. A system for supplying oxygen to a flight deck and cabin area of an aircraft in accordance with claim 13 wherein the flight deck breathing system comprises:
at least one oxygen tank;
an onboard oxygen generating system (OBOGS); and
a selector valve coupled to the oxygen tank and the OBOGS to select a source of oxygen, wherein an input of the T-fitting is coupled to on output of the selector valve.

18. A system for supplying oxygen to a flight deck and cabin area of an aircraft in accordance with claim 17 wherein the flight deck breathing system further comprises a by-pass valve coupled to the selector valve and to the at least one flight crew breathing mask to supply ambient air to the at least one flight crew breathing mask.

19. A system for supplying oxygen to a flight deck and cabin area of an aircraft in accordance with claim 18 wherein the flight deck breathing system further comprises a control circuit coupled to the selector valve and the by-pass valve to control the selector valve and the by-pass valve.

20. A system for supplying oxygen to a flight deck and cabin area of an aircraft in accordance with claim 18 wherein the control circuit is further coupled to the first regulator.
